(19) United States
(12) Patent Application Publication
(10) Pub. No.: US 2006/0260368 A1
(43) Pub. Date: Nov. 23, 2006

(54) Safety padlock

(75) Inventor: Doron Reitchuk, Holon (IL)

Correspondence Address: OSTROLENK FABER GERB & SOFFEN, 1180 AVENUE OF THE AMERICAS, NEW YORK, NY, 100368403, US

(73) Assignee: R.D.Y. Installation Commerce (2000) Ltd.

(21) Appl. No.: 11/116,514

(22) Filed: Apr. 28, 2005

(30) Foreign Application Priority Data
Jan. 12, 2005 (IL) 166260

(51) Int. Cl. E05B 67/36

(52) U.S. Cl. 70/33

(57) ABSTRACT

The present invention provides a padlock comprising a padlock body having formed therein a slot arranged to receive an object to be secured, a hasp mounted in the body and arranged to be moved between a first, inoperative position in which the slot can receive an object to be secured and a second, operative position in which it is disposed across the slot, said hasp being retained in said body in all phases of its operation and, when in the operative position, extending across the slot within the confines of the body so that the portion of the hasp securing the object is shrouded.

### BACKGROUND OF THE INVENTION

Presently available padlocks typically comprise a hasp which, when in the locked position is exposed. The hasp is looped through an object to be secured but because of the exposed nature of the hasp, both the hasp and the secured object are vulnerable to abuse. This invention relates to conventional shackle padlocks, specifically to an improved two piece shackle mechanism for padlocks.

Historically padlocks using U shaped shackles have been found to be the most popular because of the ease and convenience of their attachment to and fit with the hasps and attachment to and fit with the hasps and attachment devices with which they are used, to prevent the opening, unlatching, or coming apart of the secured elements.

The ubiquitous design, so popular for the last seventy or eighty years typically embodies a U shaped wire form that provides for the latching and locking of the shackle in the body of the padlock, and when unlocked and unlatched may be lifted so one end (the toe) is free of the body and may be pivoted around the retained end (the heel) providing sufficient clearance for the shackle to readily engaged with the mechanism (hasp) to be secured. In the most common form this is a practical, reliable, and relatively economical solution to the problem of securing spaces or things.

The U shaped wire form shackle of constant circular cross section in common use today has several shortcomings that are difficult to overcome, as may wire form shackles can be easily cut using commonly available tools. The traditional defense against this form of attack is to increase the diameter of the wire, with the consequent increase in the side of the lock body, or the choice of an alloy steel that can be hardened to make cutting more difficult. Each of these steps add significantly to the cost of the padlock. Another defense is the provision of a shield or shroud for the shackle to make access of cutting or forcing tools to the shackle and hasp staple difficult, but this defense is often costly and/or awkward to implement.

Furthermore, the latching mechanisms and shackles are often vulnerable to wedging, prying, and torsional attack because of the excessive space provided by the typical U shaped shackle and the sloppy fit with the hasp staple or attachment device which is often a characteristic of this arrangement.

In addition, the mechanical operation of lifting and pivoting the U shaped shackle is sometimes subject to malfunction caused by the environmental effects of corrosion or foreign matter (dirt and grit) within the close fitting assembly with the padlock body needed for security.

Burglary, aimed at the theft of property from both commercial and private premises, whether these be movable road vehicles such as trucks, vans, recreational vehicles, trailers, and the like, or stationary structures such as stores, warehouses, garages, barns, and the like, is an ever growing problem in our society.

Even the development of sophisticated anti-theft devices such as burglar alarms (with or without a direct link to a police station or a private protective company central office) and special pickproof locks, as well as the development of high-quality conventional padlocks and hasps, has not stemmed the tide, because the sophistication of the burglars has advanced commensurately.

Frequently, it takes a professional thief less than a minute to overcome any of the currently available anti-theft devices, even if that requires sawing or cutting through the shackle or bolt of a padlock or the staple of a hasp. By and large, of course, speed and silence in neutralizing an anti-theft device and entering the protected premises are the principal desiderata for a burglar, because they lessen the chances of his or her being detected and apprehended.

Numerous attempts have been made over the years to provide guards for conventional padlocks. The principal aim of these and other lock guard devices has been to make it more difficult and hence time-consuming for a burglar to gain access to the lock for the purpose of cutting either the bolt or shackle of the lock or the staple of an associated hasp with a bolt cutter or for sawing through such a shackle or staple with a hacksaw.

By virtue of this type of construction, the padlock as well as either the staple of the hasp or the combination staple structure of the guide track rail are rendered effectively immune to rapid and silent attack and destruction by hacksaws, bolt cutters, hammers and the like.

A so-protected structure will thus be a relatively limited interest to a prospective burglar or thief because of the higher degree of difficulty he or she will face to gain entrance to the protected premises in the shortest possible time and the least amount of noise.

Alternative padlocks have a shrouded hasp, which is required to be removed completely from the padlock body when not in use. This leads to the possibility of the hasp being lost.

Thus, by making it exceedingly difficult for a burglar or thief to overcome the hasp-type locking system of the present invention in a minimum of time and with a minimum of noise, the system will effectively inhibit burglaries of vehicles and other premises the doors of which are locked by such a hasp-type locking system.

That is not to say, of course, that the locking system of the present invention will be able to withstand a violent attack using, for example, a sledgehammer or explosives, but that type of attack will not be favored by, and is unlikely to be used by, an ordinary burglar or thief to whom any action that takes more than a minimum of time or generates more than a minimum of noise is anathema.

Accordingly, several objects and advantages of this invention are the use of a shackle incorporating a novel configuration that is easily and economically fabricated, difficult to cut or break and functionally reliable. This configuration provides increased protection to the hasp staple or attachment device by substantially filling the space available for the access of attack tools in at least one of the dimensions which define the space provided by the hasp staple or other attachment device.

It is another object of the present invention to provide such a locking system the padlock guard and other components of which are so constructed as to render an easy, simple, quiet and speedy, destruction of any part of the lock or its mounting in use effectively impossible, and which, in contrast, will require so much effort, time and noise by a burglar to destroy the lock and its mounting as to materially increase the burglar's risk of detection and apprehension.

It is therefore a principal object of the present invention to provide a sliding padlock which will provide a tight fit in order to prevent the insertion of prying or cutting tools there between.

Another object of the present invention is to provide a tight fitting padlock to which a shield may be attached and which may be utilized with a variety of hasp sizes.

It is a further object of the present invention to provide a sliding bolt padlock, which is both reliable and inexpensive to manufacture.

It is to be emphasized that the present invention, though similar in shape, is completely different in its operating mechanism than the prior Israel patent application number 161048 filed by the same inventor in March 2004.

### SUMMARY OF THE INVENTION

It is an object of the present invention to provide a padlock wherein the hasp is retained with the padlock body in all phases of its operation and which is not exposed when in the locked position.

The present invention provides a padlock comprising a padlock body having formed therein a slot arranged to receive an object to be secured, a hasp mounted in the body and arranged to be moved between a first, inoperative position in which the slot can receive an object to be secured and a second, operative position in which it is disposed across the slot, said hasp being retained in said body in all phases of its operation and, when in the operative position, extending across the slot within the confines of the body so that the portion of the hasp securing the object is shrouded.

Other features and advantages of the present invention will become apparent from the following description of the invention that refers to the accompanying drawings.

### BRIEF DESCRIPTION OF THE DRAWINGS

The above-noted and other features of the shelter will be better understood from the following detailed description, when considered with reference to the accompanying diagrams in which:

FIG. 1 is a drawing of the padlock.

FIG. 2 is a photo providing a view of the padlock in unlocked conditions.

FIG. 3 is a photo providing a view of the padlock in a locked condition.

### DETAILED DESCRIPTION OF EMBODIMENTS OF THE INVENTION

The padlock of the present invention includes a frame having a base on which a shackle slides. The slideable shackle includes a main body that extends into a toe portion. The toe portion of the shackle includes tapered sidewalls that are separated by a distance that gradually decreases toward the distal end of the toe.

The padlock includes means for maintaining the sliding bolt in a locked position and the entire padlock may be housed in a casing to hide at least the staple of the hasp.

The invention includes fastening means, which is adapted to be removeably connected to a doorjamb and to cooperate with a sliding shackle padlock, in place of a hasp device, to secure a door from unauthorized intrusion.

The lock has a flat-faced cylindrical housing and an internal key cylinder-operable bolt, which can be selectively protracted through a hasp staple or the like inside a channel in the housing, which intersects the path or movement of the bolt.

In use, the lock is slid into and out of the guard, the latter being circumferentially interrupted to a limited extent at one part thereof corresponding to the location of and to provide access to the key cylinder of the padlock.

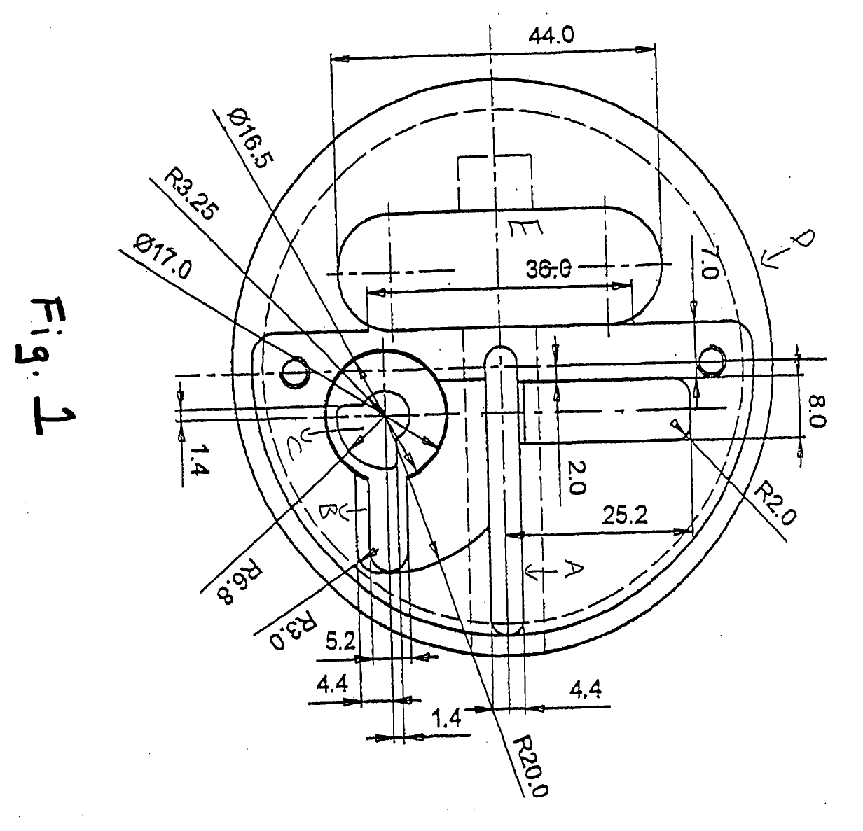

This padlock comprises a body having formed therein a slot wide enough and deep enough to accept a pad-bolt tongue or a chain link or the lock. The tunnel extends across the slot. In use, the bolt is normally urged outwardly by the spring so as to be clear of the clot. This unlocked condition is shown in FIG. 1.

When desired to secure an object, the said object is placed in the slot deeper than the tunnel. Then the bolt is pressed inwardly so as to pass through the slot and an aperture in the object to be secured.

When released, the bolt automatically urged back to the position shown in FIG. 1 by the action of the spring and thus the object is released.

The padlock is unlocked by a key. This returns the pinion and rack to the position shown in FIG. 1, in which the pawl is in engagement with the notch. The compression spring can be located within, about or alongside the rack.

A slot extending substantially across the width of the base is provided near one end of the padlock so that a staple of a hasp may pass therethrough.

In order to unlock the shackle, a cam arrangement which is activated by the turning of a key inserted into a keyway is utilized. The cam arrangement includes a cam section, which upon the turning of the key rotates thereby separating the projection of the spring to a point where the head may pass between.

In order to facilitate the unlocking of the lock, a spring may be associated with the sliding bolt to assist in urging the rounded head in any direction of the cylinder.

A slot extends through the base of the padlock through which can project the staple of a hasp. The padlock is placed over the staple, so that the staple passes through the slot and the shackle is slid towards the staple so that the toe portion passes through the opening of the staple until the projections of spring capture the head, as described above. To release the spring, the key is inserted in the keyway and turned thereby.

The padlock is built in a shroud placed over the locking mechanism and completely surrounding the locking mechanism thereby preventing access to the components of the padlock.

As the sliding shackle is moved toward the recess and locking mechanism, the flat spring plate bears against the inclined surfaces of the ratchet teeth and is biased in the downward direction until it reaches the apex between the inclined surface and the vertical surface whereupon the flat spring plate returns to its normal position to engage the vertical surface and thereby lock the sliding shackle against movement in the opposite direction.

The shackle includes a cylinder lock having a retractable lock pin, which is actuated by key. The cylinder lock can be any conventional commercially available lock, which is suited for disposition within the tapered padlock. The retractable lock pin operates as a pawl in conjunction with base.

The base of the padlock includes a protective cover portion having shackle chamber defined by walls. A shackle opening in communication with the exterior of protective cover and the shackle chamber is provided to receive sliding shackle.

Once the retractable lock pin rides over the apex of the inclined surface and the vertical surface, the spring of lock pin will again bias the lock pin so that it will engage the vertical surface and the shackle cannot be removed from within the shackle chamber.

With such an arrangement, the staple of the hasp is entirely hidden within the protective cover and tapered feature of the shackle provides a tight arrangement such that the sliding shackle padlock becomes fixed to the staple of the hasp and is not easily removed therefrom to open the door or other closure to be locked.

It is to be noted that the number of and space between the ratchet teeth can be varied so that shackle can be longitudinally moved into the shackle chamber and smaller increments thereby providing a greater degree of adjustability and thus a more snug arrangement within the staple opening of staple.

Thus, when the padlock is assembled and locked on a staple, the door or other closure sought to be locked is secured against unauthorized access as in the previous embodiment.

In accordance with the concepts underlying the present invention, the staple will be hidden and inaccessible to cutting or prying tools, and will further provide protection against a torsional attach on the sliding shackle padlock as the top portion of the staple is disposed within the staple recess.

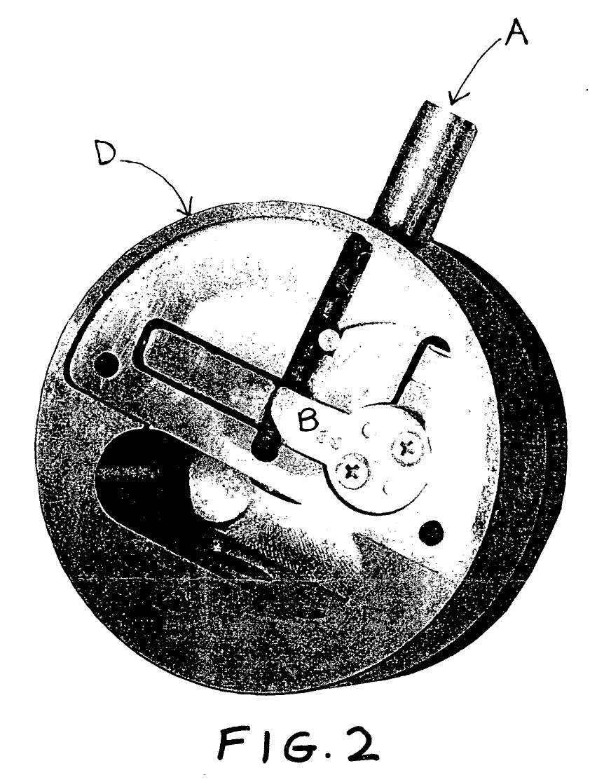

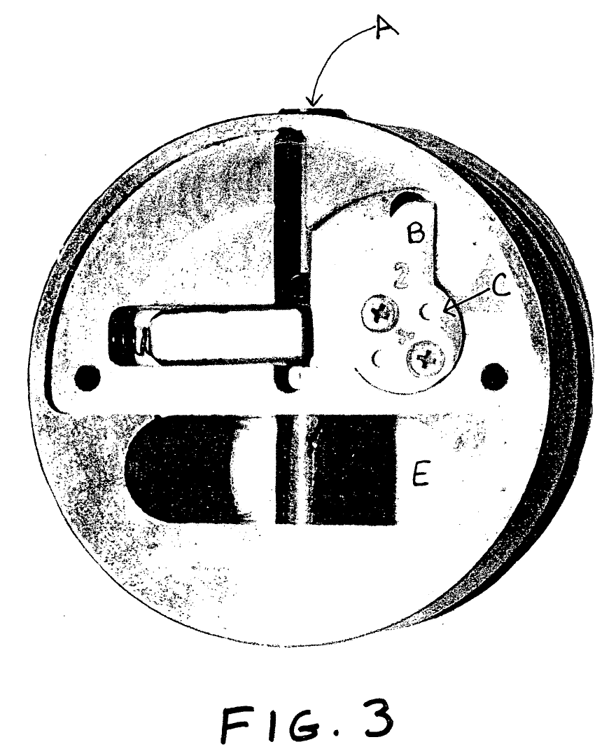

In FIGS. 1-3, the character reference numerals indicate the following:

Element A is the integrative shackle.

Element B is the locking mechanism.

Element C is the keyhole.

Element D is the main body of the padlock.

Element E is the locking area of the shackle.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A padlock wherein the hasp is retained with the padlock body in all phases of its operation and which is not exposed when in the locked position.

2. A padlock comprising a padlock body having formed therein, a slot arranged to received an object to be secured, a hasp mounted in the body and arranged to be moved between a first, inoperative position in which the slot can receive an object to be secured and a second, operative position in which it is disposed across the slot, said hasp being retained in said body in all phases of its operation.

3. The padlock of claim 1, which includes a frame having a base on which a shackle slides, the slideable shackle extends into a toe position, the toe portion of the shackle includes tapered side walls that are separated by a distance that gradually decreases toward the distal end of the toe.

4. The padlock of claim 1, which maintains the sliding bolt in a locked position and the entire padlock is housed in a casing to hide the hasp.

5. The padlock of claim 1, which includes fastening means, which is adapted to be removeably connected to a doorjamb and to cooperate with a sliding shackle padlock.

6. The lock of claim 1, which has a flat-faced cylindrical housing and an internal key cylinder-operable bolt, which can be selectively protracted through a hasp staple or the like outside a channel in the housing which intersects the path of movement of the bolt.

7. The lock of claim 1, which in use, the lock is slid into and out of the guard, the latter being circumferentially interrupted to a limited extent at one part thereof corresponding to the location of and to provide access to the key cylinder of the padlock.

8. The padlock of claim 1, including a bolt that is pressed inwardly so as to pass through a slot and an aperture in an object to be secured.

9. The padlock of claim 1, including a slot extending substantially across the width of a base provided near one end of the padlock so that a staple of a hasp may pass therethrough.

10. The padlock of claim 1, wherein to unlock a shackle, a cam arrangement, which is activated by the turning of a key inserted into a keyway, is utilized, the cam arrangement includes a cam section, which upon the turning of the key rotates thereby separating the projections of the spring to a point where the head may pass between.

11. The padlock of claim 1, wherein in order to facilitate the unlocking of the lock, a spring is associated with the sliding bolt to assist in urging the rounded head in any direction of the cylinder.

12. The padlock of claim 1, including a slot extending through the base of the padlock through which can project the staple of a hasp, the padlock is placed over the staple, so that the staple passes through the slot and the shackle is slid towards the staple passes through the slot and the shackle is slid towards the staple so that the toe portion passes through the opening of the staple until the projections of the spring capture the head, and to release the spring, the key is inserted in the keyway and turned thereby.

13. The padlock of claim 1, wherein the padlock is built in a shroud placed over the locking mechanism and completely surrounding the locking mechanism thereby preventing access to the components of the padlock.

14. The padlock of claim 1, wherein as a sliding shacked is moved towards the recess and locking mechanism, a flat spring plate bears against the inclined surface of the ratchet teeth and is biased in the downward direction until it reaches the apex between the inclined surface and the vertical surface whereupon the flat spring plate returns to its normal position to engage the vertical surface and thereby lock the sliding shackle against movement in the opposite direction.

15. The padlock of claim 14, wherein the shackle includes a cylinder lock having a retractable lock pin, which is actuated by key, the cylinder lock can be any conventional commercially available lock, which is suited for disposition with the tapered padlock, and a retractable lock pin operates as a pawl in conjunction with base.

16. The padlock of claim 15, wherein the base of the padlock includes a protective cover portion having a shackle chamber defined by walls, a shackle opening in communication with the exterior of protective cover and the shackle chamber is provided to receive sliding shackle.

17. The padlock of claim 16, wherein once the retractable lock pin rides over the apex of the inclined surface and the vertical surface, the spring of lock pin will again bias the lock pin so that it will engage the vertical surface and the shackle cannot be removed from within the shackle chamber.

18. The padlock of claim 14, wherein a staple of hasp is entirely hidden within the protective cover and a tapered feature of the shackle provides a tight arrangement such that the sliding shackle padlock becomes fixed to a staple of the hasp and is not easily removed therefrom to open the door or other closure to be locked.

19. The padlock of claim 1, wherein when the padlock is assembled and locked on a staple, the door or other closure sought be locked is secured against unauthorized access, the staple is hidden and inaccessible to cutting or prying tools, and provides protection against a torsional attack on the sliding shackle padlock as the top portion of the staple is disposed within staple recess.
